(19) United States
(12) Patent Application Publication
(10) Pub. No.: US 2020/0070046 A1
(43) Pub. Date: Mar. 5, 2020

(54) SYSTEM AND METHOD FOR CONTROLLING A VIRTUAL WORLD CHARACTER

(71) Applicant: Dan Sivan, Herzelia (IL)

(72) Inventor: Dan Sivan, Herzelia (IL)

(21) Appl. No.: 16/117,784

(22) Filed: Aug. 30, 2018

(51) Int. Cl. A63F 13/23; G06F 3/01; G06F 3/0346; G06F 3/14; A63F 13/24; A63F 13/285; A63F 13/212

(52) U.S. Cl. CPC A63F 13/23; G06F 3/012; G06F 3/016; G06F 3/0346; G06F 3/02; A63F 13/24; A63F 13/285; A63F 13/212; G06F 3/1454

(57) ABSTRACT

A system and method for controlling a virtual world character utilizing a virtual world character having the same appearance as a handheld controller. The system comprises the handheld controller, a computing device, and a head-mount-display device. The handheld controller is operative to store identity information relating to the appearance of the controller, measure any physical manipulations by a user to generate input information, and transmit this input and identity information to the computing device. The computing device is operative to receive this information from the handheld controller, generate a virtual environment in accordance with the information, and transmit the virtual environment to the head-mount display device. The head-mount display is configured to be worn on the user's head and is operative to determine the position and orientation of the user's head, receive and display the virtual environment.

### GOVERNMENT CONTRACT

Not applicable.

### CROSS-REFERENCE TO RELATED APPLICATIONS

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to field of virtual reality and, more particularly, to a system and method for controlling a virtual world character using a handheld controller shaped and appearing identical to the virtual world character.

### BACKGROUND

Virtual reality gameplay often includes imaginary characters participating in fictional events, activities, and transactions. Such interactions are possible due to the combination of virtual reality software and enhanced display technology. Virtual reality may be utilized for educational or entertainment purposes. Through a virtual perspective, the user may experience a new destination or activity not previously possible due to real world constraints. Indeed, the realm possible environments in which the user may immerse himself or herself is virtually limitless.

There are two main types of virtual reality gameplay: first person and third person. First person involves the user participating directly in the virtual realm. Meanwhile, third person systems typically allow the participant to view himself or herself or a portion thereof, such as just the arms or hands, on a display of a specific environment. One issue with placing a human user in a virtual environment is virtual reality “jerk” or virtual reality sickness. The virtual reality jerk results from acceleration and other sudden movements in the virtual space. Third person virtual reality mitigates this problem to an extent by allowing a user to make sudden jumps, spins, or without the motion making them sick. There exists a need for a virtual reality system wherein the user does not experience virtual reality jerk.

Virtual reality gaming systems typically include a head-mount display device as the standard output device but there is no standard input device. Some systems permit operation through hand or body gestures and utilize cameras or other sensors in order to detect such movements. Other systems involve the use of a device or controller. These controllers often take on a standard, ergonomic shape, either adapted to be worn over the user's hand, such as a glove, or held therein.

One problem with ergonomically-shaped controllers is that they do not feel realistic. To make the experience more realistic, some attempts have included providing a game controller with haptic feedback. Other attempts to solve this issue have occurred with respect to controllers shaped as firearms, for example. However, no controllers known in the art permit a user to truly feel as though the device they are controlling is actually being manipulated in the virtual environment. Thus, there also exists a need for action figure virtual reality.

### SUMMARY

A method and system are provided for controlling a virtual world character using a handheld controller shaped and appearing identical to the shape and appearance of the virtual world character. A virtual reality system is provided that utilizes a computing device, which allows the virtual world character to perform actions within a virtual reality environment based on physical manipulations of the handheld controller. Following the occurrence of a physical manipulation of the handheld controller, the computing device generates the virtual world character acting so as to mirror the physical manipulations. The virtual reality environment is displayed to the user via a head-mount display device. The ultimate result is providing a virtual reality experience wherein the user may perform a supervisory, third party-function while maintaining first person presence within the virtual environment.

Briefly described, one embodiment, among others, is a system for controlling the virtual world character that comprises the handheld controller, the computing device, and the head-mount display device. The handheld controller may be operative to: store the identity information about one or more aesthetic traits, personality traits, or skill traits of the virtual world character, measure any physical manipulations from the user, and transmit the identity information and the input information to the computing device. The computing device may be operative to: receive input information and identity information from the handheld controller, generate a virtual environment in accordance with the identity information and the input information, generate output information based on the input information and identity information, and transmit the output information to the head-mount display device. The head-mount display may be configured to be worn on the user's head and may be operative to: determine the position and orientation of the user's head, receive output information from the computing device, and display the virtual environment.

In some embodiments, the virtual world character may have a shape and appearance that is identical to the shape and appearance of the handheld controller. Further, the handheld controller may be configured into a desirable character, such as a superhero. In such embodiments, the virtual world character may also be configured into the same desirable character. Moreover, the handheld controller may comprise a microchip operative to record the information relating to the shape, appearance, and desirable character identity of the handheld controller as identity information. The identity information may further comprise one or more aesthetic traits, such as hair color and body shape, one or more personality traits, such as brave, and one or more skill traits, such as fast or strong. Each embodiment of the virtual world character may have its own associated traits. The identity information may be transmitted to the computing device.

The handheld controller may further have one or more input devices, such as a button, switch, or trigger. Upon the receipt of physical manipulations by a real-world user, such as actuating a button or thrusting the handheld controller within real-world space, the controller measures the manipulations, thereby creating input information. Indeed, the user may physically manipulate the handheld controller by moving the controller itself within the real-world space or by actuating the one or more input devices. When one or more input devices are actuated, the handheld controller may be further operable to provide force feedback to the user. The physical manipulations of the handheld controller create input information, which may be transmitted to the computing device.

Responsive to the identity information and input information transmitted by the handheld controller, the computing device receives the identity information and the input information. The computing device is further operative to adapt the appearance and other characteristics of the virtual world character in accordance with the identity information. Similarly, the computing device is operative to receive the input information and facilitate control of the virtual world character in accordance with the physical manipulations of the handheld controller by the user.

Upon receipt of the input information and the identity information, the computing device is operative to adapt a virtual world environment using multimedia information. The multimedia information may comprise features of games already known in the art or may comprise a novel game. A person of ordinary skill in the art will recognize virtually every computer game may be adaptable in accordance with this invention. At a basic level, the multimedia information may comprise one or more interactive objects, one or more non-interactive objects, and one or more audible elements. The one or more interactive objects may be configured in a number of ways, for example, as a computer-controlled character, a virtual weapon, or a virtual vehicle. The virtual world character may interact with the interactive objects by, for instance, attacking, grasping, pushing, or mounting. The non-interactive objects may comprise, for example, a wall/barrier, a rock, or a computer-controlled non-enemy character, with which the virtual world character may not interact. The one or more audible elements may correspond to actions of the virtual world character in the virtual environment and may comprise any type of noise. The computing device is further operative to generate the input information, multimedia information, and identity information into output information. The computing device may thereafter be operative to transmit the output information. In certain embodiments, the computing device may also be operative to record and store data relating to gameplay. In such embodiments, the user is able to later retrieve this gameplay data.

The system may further include the head-mount display device configured to be worn on the user's head and receive the output information from the computing device. The head-mount display device may be further operative to determine the position and orientation of the user's head in the real-world space. In some embodiments, the head-mount display device may further comprise one or more sensors to this end. Indeed, the one or more sensors may be capable of measuring positional information and communicating the positional information to the display device. In other embodiments, the head-mount display device may be further operative to emit signals relaying the positional information. In such embodiments, the system may further comprise one or more sensor stations, separate from the head-mount display device, which may be operative to sense the signals emitted from the head-mount display device.

Upon determining the position of the user's head relative to the real-world space and receiving the output information from the computing device, the head-mount display device may be operative to display of the virtual environment to the user. In some embodiments, a separate monitor may be provided and may be operative to display the virtual environment so as to mirror the display via the display device. The display may show the virtual world character, the one or more interactive objects, and the one or more non-interactive objects. In some embodiments, the head-mount display device may deliver the one or more audible elements, while in others, the one or more audible elements may be delivered to the user via the monitor. As the user physically manipulates the handheld controller, actions of the virtual world character with respect to the virtual environment are updated in real time at the head-mount display device and the one or more audible elements may be delivered to the user accordingly.

In one embodiment of the present invention, a computer-implemented method is used to facilitate control of the virtual world character by the user using the handheld controller and wearing the head-mount display device. The method comprises the steps of providing a handheld controller defined by identity information; at the handheld controller, receiving and measuring physical manipulations of the handheld controller to define input information; transmit the identity information and input information to a computing device; at the computing device, receiving the transmitted identity information and input information from the handheld controller and generating a virtual environment; at the computing device, transmitting the virtual environment to a head-mount display device worn by the user; and at the head-mount display device, determining the position and orientation of the user's head; at the head-mount display device, displaying the virtual environment; and altering the virtual environment in response to the physical manipulations of the handheld controller.

As discussed above, the virtual world character may be defined by identity information and, in turn, the handheld controller may also be defined by identity information. The handheld controller may include a microchip, which records this identity information. The handheld controller may then communicate the identity information to the computing device.

Initially, the virtual environment is generated as a function of the multimedia information and the input information and identity information transmitted by the handheld controller. In particular, the multimedia information may include one or more interactive objects, one or more non-interactive objects, one or more pre-loaded character traits, and one or more audible elements. In some embodiments, the identity information of the virtual world character, which may further include one or more aesthetic traits, one or more personality traits, and one or more skill traits, is automatically transmitted to the computing device and the virtual world character automatically possesses the relevant aesthetic traits, personality traits, and skill traits. In other embodiments, the user is given the option of controlling the virtual world character in accordance with the identity information or controlling the virtual world character in accordance with the one or more pre-loaded character traits, as desirable.

As generated, the virtual world environment is displayed to the user wearing the head-mount display device. In certain embodiments, a separate monitor is also provided which mirrors the virtual environment displayed by the head-mount display device. The head-mount display device may also deliver the one or more audible elements to the user. In other embodiments, the monitor may deliver the one or more audible elements to the user. The head-mount display device further determines the position and orientation of the user's head relative to the real-world space and adapts the display accordingly so as to simulate a real-world experience for the user in the virtual environment. For instance, if the user tilts his or her head to the side in the real-world space, the display should similarly adjust so as to provide a corresponding point of view of the virtual environment.

When the user physically manipulates the handheld controller, the actions of the virtual world character change so as to correspond to the physical manipulations. The handheld controller may thereby control the virtual world character and may further cause the virtual world character to interact with an interactive object or move around in the virtual environment. To the contrary, the virtual world character is prevented from interacting with the one or more non-interactive objects, which may thereby serve as barriers or limitations of movement within the virtual environment. When such interactions or non-interactions take place, the corresponding one or more audible elements may be delivered to the user via the display device. The virtual environment is displayed to the user via the head-mount display device and is updated in real-time in accordance with physical manipulations of the handheld controller by the user.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 illustrates an embodiment of a system for controlling a virtual world character.

FIG. 2 illustrates an exemplary embodiment of the system in accordance with one embodiment of this invention.

FIG. 3 illustrates an exemplary embodiment of the system in accordance with one embodiment of this invention.

FIG. 4 illustrates an exemplary embodiment of the system in accordance with one embodiment of this invention.

FIG. 5 is a flowchart depicting an exemplary method of controlling a virtual world character.

FIG. 6 is a block diagram illustrating an exemplary embodiment of a computing device configured to implement the system and method.

FIG. 7 is a block diagram illustrating an exemplary embodiment of a handheld controller configured to implement the system and method.

FIG. 8 is a block diagram illustrating an exemplary embodiment of a head-mount display device configured to implement the system and method.

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

A system and method for controlling a virtual world character from a third-person perspective is provided that, in some embodiments, permits a real-world user to physically manipulate a handheld controller, having a shape identical to the shape of the virtual world character, to generate actions of the virtual world character that mirror the physical manipulations in a virtual environment. The system and method permits the user to feel present in the virtual environment as a first person and to control the actions of the virtual world character from a third-person perspective. Embodiments may be possible wherein the system further comprises more than one handheld controller for the user to physically manipulate or more than one handheld controller for multiple users to physically manipulate. However, for purposes of brevity and clarity, one embodiment where in the system comprises one handheld controller for use by a single user will be discussed.

By way of example, and not limitation, the handheld controller may be configured in the shape of a desirable character, such as a superhero. In such embodiments, the virtual world character corresponds to this desirable character and appears in a virtual environment as identical to the handheld controller. Indeed, the handheld controller may be operative to communicate information regarding the identity of the desirable character. For instance, in embodiments where the handheld controller is shaped as a superhero, the virtual world character identically appears as the same superhero. Further, and as discussed more below, the virtual world character may portray one or more aesthetic traits, personality traits, and skill traits identical to that of the desirable character associated with the handheld controller.

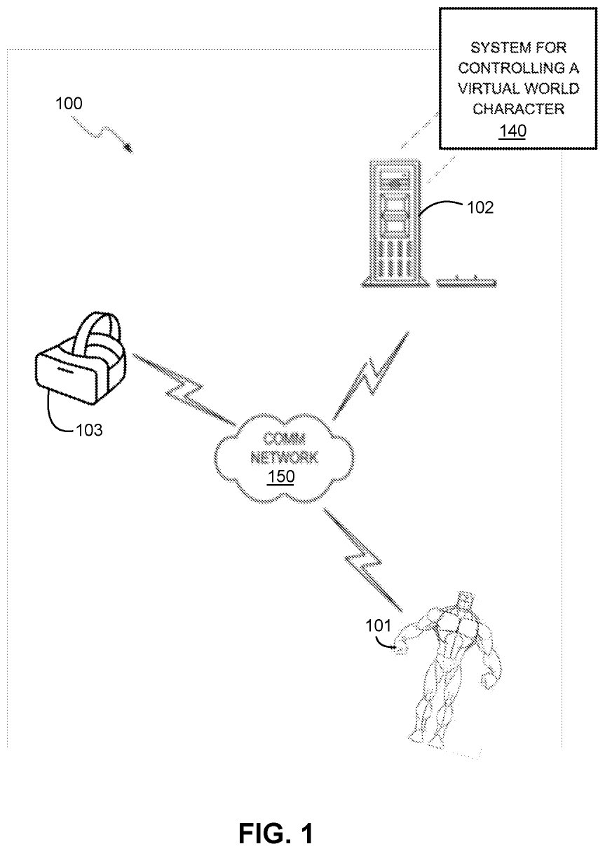

FIG. 1 is illustrative of a networked environment 100 in which an embodiment of a system for controlling a virtual world character 140 is implemented. As shown in FIG. 1, the system 140 comprises a plurality of electronic devices. By way of example, and not limitation, a handheld controller 101, a computing device 102, and a head-mount display device 103 re shown communicatively coupled via a communication network 150. Notably, the communications network 150 can use one or more of various communications types such as, for example and without limitation, cellular and Wi-Fi communications. Moreover, each of the handheld controller 101, the computing device 102, and the head-mount display device 103 may be coupled to a power supply. This may be effectuated by way of a power cord, battery, or other means of supplying electrical power as may be available or otherwise desired.

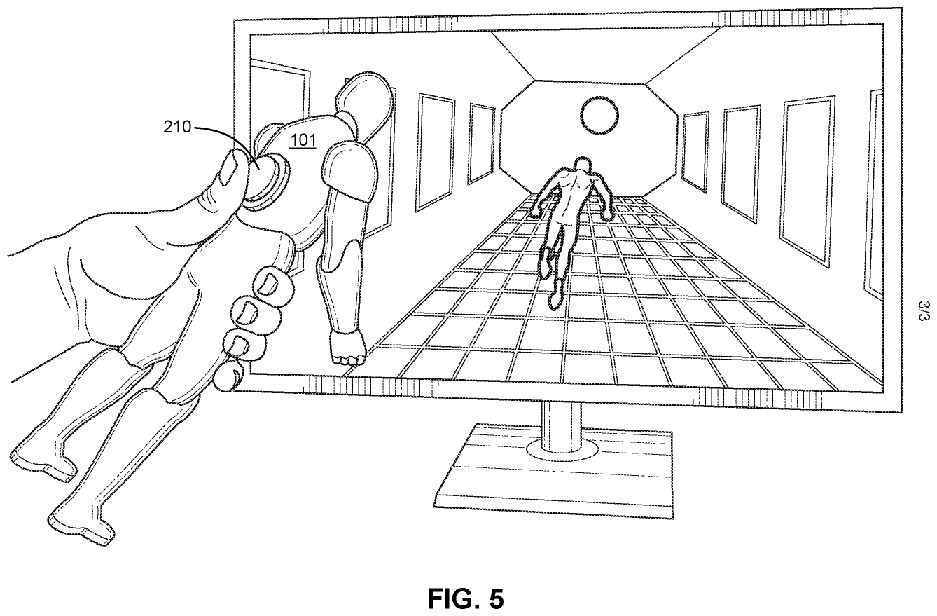

In order to facilitate the aforementioned functionality, various aspects may be performed by one or more of the electronic devices 101, 102, and 103. In one embodiment, the electronic devices are operative to perform, at least in part, the method depicted in the flowchart of FIG. 5 and described below.

If embodied in software, it should be noted that each block depicted in the accompanying flowcharts represents a module, segment, or portion of code that comprises program instructions stored on a non-transitory computer readable medium to implement the specified logical function(s). In this regard, the program instructions may be embodied in the form of source code that comprises statements written in a programming language or machine code that comprises numerical instructions recognizable by a suitable execution system such as the computing device 102. The machine code may be converted from the source code, etc. If embodied in hardware, each block may represent a circuit or a number of interconnected circuits to implement the specified logical function(s).

In some embodiments, and as stated earlier, the handheld controller 101 may be defined by identity information, that identity information thereby also defining the virtual world character, that is, the virtual world character may have a shape and appearance identical to the shape and appearance of the handheld controller. The handheld controller 101 may be operative to store the identity information. In certain embodiments, the handheld controller 101 may comprise a microchip, such as a random-access memory chip, read only memory chip, static random-access memory chip, first in, first out memory chip, erasable programmable read only memory chip, or a programmable read only memory chip. The microchip may be operative to store the identity information.

The identity information may comprise one or more aesthetic traits, one or more personality traits, and one or more skill traits. In the context of a virtual environment, the one or more aesthetic traits may appear as varying hair colors of the virtual world character, such as blonde, brunette, red, or black, or varying body shapes, such as tall, short, muscular, slender, lean, round, or chubby.

The one or more personality traits may vary the actions of the virtual world character. For instance, a personality trait may be “silly” and the virtual world character may accordingly dance in a quirky manner upon a perceived victory during gameplay. As another example, a personality trait may be “confident” and the virtual world character may accordingly stand in a proud manner after a perceived victory.

Similarly, the one or more skill traits may include abilities such as speed, strength, invisibility, and precise aim, and may change the manner in which actions are performed by the virtual world character. For example, a virtual world character associated with the skill trait of “fast” may be capable of moving through the virtual environment at a quicker pace as compared to other virtual world characters not having this skill trait. Moreover, each embodiment of the virtual world character may have its own associated aesthetic traits, personality traits, and skill traits. In some embodiments, the user may be able to alter one or more of the aesthetic traits, personality traits, or skill traits. In other embodiments, the aesthetic traits, personality traits, and skill traits may be static. A person of ordinary skill in the art will recognize a variety of aesthetic traits, personality traits, and skill traits may be possible in accordance with this invention. The above examples are provided only by way of example, and not of limitation. The handheld controller 101 may be operative to transmit the identity information to the computing device 102.

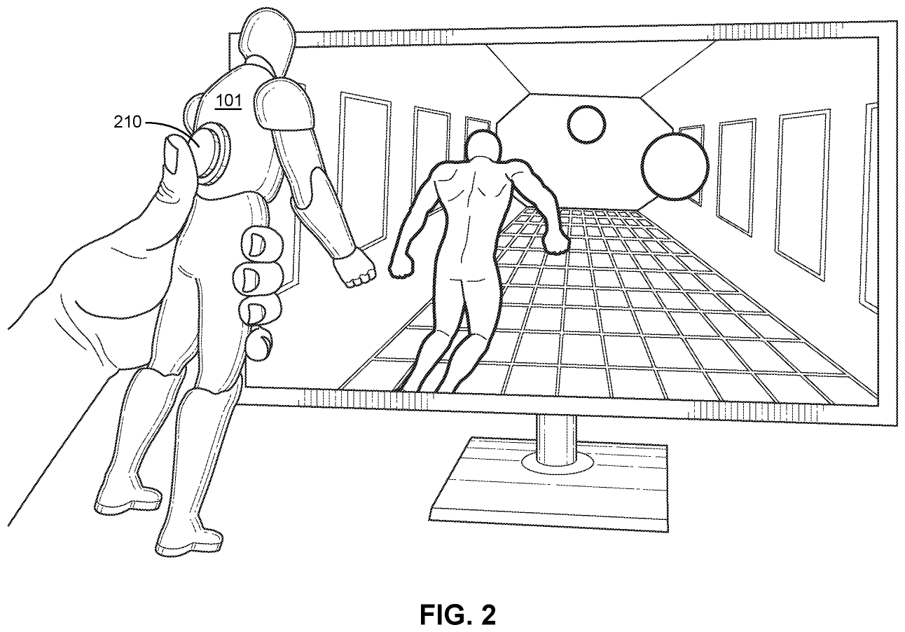

With attention now to FIG. 2, the handheld controller 101 may be further operative to receive and measure physical manipulations from the user and may comprise one or more input devices 210. The one or more input devices 210 may variously be formed as buttons, switches, triggers, joysticks, trackballs, gamepads, paddles, throttle quadrants, steering wheels, yokes, pedals, or handles. Moreover, the one or more input devices 210 may comprise a keyboard, a microphone, an image scanner, a touchpad, a trackpad, or a touchscreen. The one or more input devices 210 may be actuated in a variety of ways and the manner of actuation may depend on the type and form of the input device. For instance, in embodiments where the one or more input devices 210 may include a button, the button may be actuated by the user exerting physical pressure thereon. As another example, in embodiments where the one or more input devices 210 may include a joystick, the joystick may be pivoted around its base by the user.

In some embodiments, the handheld controller 101 may be operative to measure physical manipulations resulting from movements of the handheld controller 101 itself in the real-world space. By way of example, the user may thrust in a forward direction, rotate around an axis, or jostle the handheld controller 101. In certain embodiments, the handheld controller 101 may be further operative to provide force feedback to the user. To this end, the handheld controller 101 may comprise a haptic driver operative to provide haptic effects. For example, upon actuation of an input device associated with firing a firearm in the virtual environment, the haptic driver may cause the handheld controller 101 to vibrate. As another example, the handheld controller 101 may be operative to give the impression of weight or resistance. In yet further embodiments, the handheld controller 101 may further comprise one or more accelerometers or other positional sensors that may be capable of detecting the orientation, position, and acceleration of the handheld controller 101 in real-world space. Indeed, the handheld controller 101 may one or more comprise motion tracking sensors and may be further operative to measure sensed movements. Upon receiving the physical manipulations by the user, the handheld controller 101 may be operative to create input information based on the measured manipulations from the user. The handheld controller 101 may then transmit the input information to the computing device.

With attention back to FIG. 1, the computing device 102 may be operative to receive the input information and identity information transmitted by the handheld controller 101. With respect to the identity information, the computing device 102 may be operative to generate the virtual world character in accordance with the identity information, that is, the virtual world character may be generated so as to have the same appearance as the handheld controller 101. In particular, the computing device 102 may adapt the one or more aesthetic traits, one or more personality traits, and one or more skill traits of the virtual world character.

In some embodiments, the computing device 102 may be further operative to store multimedia information. The multimedia information may thereby be retrievable from the computing device 102 and may comprise one or more interactive objects, one or more non-interactive objects, and one or more audible elements. The multimedia information may further comprise elements and features of games already known in the art. Moreover, the multimedia information may comprise novel elements and features not known in the art. A person of ordinary skill in the art will recognize virtually every computer game may be adapted in accordance with this invention. In alternate embodiments, the multimedia information may be stored on and retrievable from a separate server.

The one or more interactive objects may be variously formed to be virtually tangible or virtually intangible. In embodiments where the one or more interactive objects may be virtually tangible, the interactive objects may be a computer-controlled character, another player-controlled character, a weapon, ammunition, food, a vehicle, or a shelter. In alternate embodiments where the one or more interactive objects may be virtually intangible, the interactive objects may comprise a temporary skill boost (known as a power-up), an extra life, a game hint or trick, or a means to enter a new level.

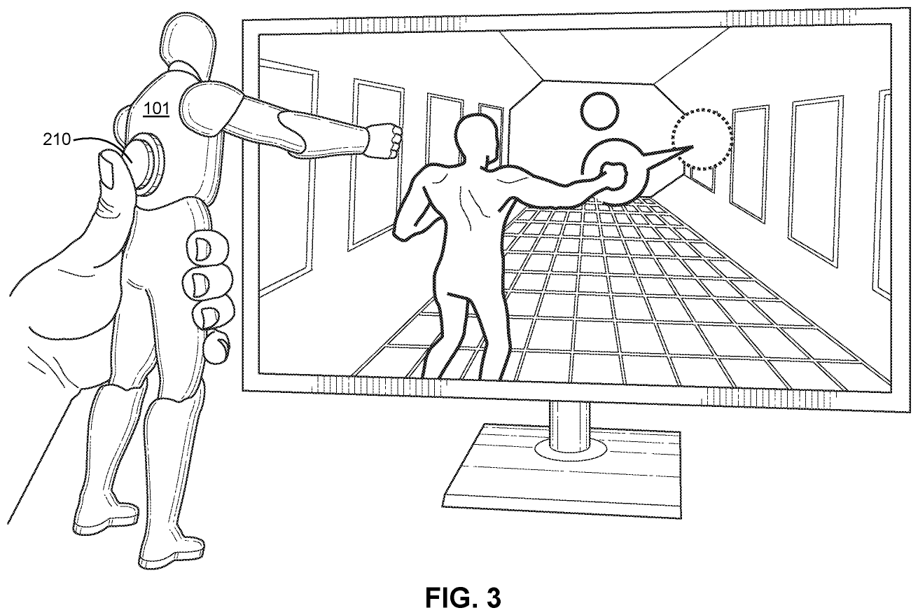

The computing device 102 may be further operative to determine the virtual world character's position with respect to the one or more interactive objects and facilitate interaction between the virtual world character and the interactive objects. In particular, and as can be seen with respect to FIGS. 2-3, the computing device may be operative to enable the virtual world character to interact with the one or more interactive objects in a variety of ways. Indeed, a person of ordinary skill in the art will envision virtually limitless possibilities of actions the virtual world character may take with respect to the one or more interactive objects. Further, the virtual world character may directly or indirectly interact with the one or more interactive objects. By way of example, the virtual world character may directly or indirectly attack, hit, kick, grasp, tap, push, pull, mount, carry, or swipe the interactive objects. For instance, and as illustrated in FIG. 3, the virtual world character may shoot at an interactive object, such as a target.

In certain embodiments, the one or more non-interactive objects may provide visual appeal to the virtual environment and the virtual world character may not be able to interact with the non-interactive objects. The computing device may therefore be operative to determine the virtual world character's position with respect to the non-interactive objects and disallow interaction between the virtual world character and the non-interactive objects. In some embodiments, the non-interactive objects may serve the purpose of limiting the bounds of the virtual environment. To that end, the computing device may be further operative to disallow placement of the virtual world character within a certain boundary surrounding the non-interactive object. For instance, the non-interactive objects may comprise a wall or barrier into which the virtual world character cannot move. As another example, the non-interactive object may also comprise a player-controlled virtual teammate or computer-controlled virtual teammate, who may not be attacked or otherwise interacted with by the virtual world character.

The multimedia information may also comprise one or more audible elements. The audible elements may comprise a hum, thud, thump, crash, jingle, jangle, swish, clatter, crunch, tinkle, vibration, reverberation, squawk, clank, clack, clash, creak, cough, swoosh, splash, screech, growl, snarl, slurp, roar, buzz, boom, hiss, purr, fizz, drip, flutter, groan, gurgle, rattle, sizzle, trumpet, tweet, chirp, or squeak. Moreover, the audible elements may further comprise songs or musical tones. One of ordinary skill in the art will recognize other types of audible elements may be possible in accordance with this invention. In some embodiments, the audible elements may correspond to actions taken by the virtual world character and other events taking place in the virtual environment. In alternate embodiments, the audible elements may remain constant and unaltered by events in the virtual environment. For example, in embodiments where the one or more audible elements may comprise a song, said song may play constantly in the background.

Turning attention back to FIG. 1, the computing device 102 may be further operative to receive the input information and identity information transmitted by the handheld controller. Moreover, the computing device 102 may generate output information defined by the virtual environment, the input information, and identity information. The computing device 102 may then be operative to transmit the output information to the head-mount display device 103.

In some embodiments, the head-mount display device 103 may be configured to be worn on the user's head and may be operative to determine the position and orientation of the user's head, receive the output information from the computing device 102, and then generate a display of the virtual environment. More specifically, the head-mount display device may comprise one or more sensors and a visual display.

The one or more sensors may be capable of determining the position and orientation of the user's head to create positional information. In certain embodiments, the system 100 may further comprise one or more sensor stations. In such embodiments, the head-mount display device 103 may be further operative to emit signals and the one or more sensor stations may be operative to sense the signals emitted therefrom. Upon sensing signals from the head-mount display device 103, the sensor stations may be operative to determine the position and orientation of the user's head to create positional information and then may transmit the positional information to the display device 103. The sensor stations may therefore be operative to communicate with the head-mount display device 103 via the communication network and may be coupled to a power supply, such as those discussed above.

The visual display may render the virtual environment in a manner visible to the user and may be formed out of a liquid crystal display panel, light emitting diode screen, organic light emitting diode screen, electrophoretic display, cathode ray tube, liquid crystal on silicon, plasma panel display, virtual retinal display, or a combination of the aforementioned materials. A person of ordinary skill in the art will recognize the head-mount display device 103 may comprise any other types of display technologies known to those in the art. The head-mount display device 103 may be operative to incorporate the positional information from the sensors or sensor stations, as the case may be, and generate the visual display so as to alter the perspective from which the user views the virtual environment. Indeed, the visual display may be adjusted as the positional information is updated. In certain embodiments, the visual display may be adapted in real time as the positional information is updated.

In some embodiments, the system may further comprise a monitor. The monitor may be operative to display the virtual environment. The virtual environment as displayed by the monitor may mirror the visual display of the virtual environment visible to the user wearing the head-mount display device. In such embodiments, while one user may be physically manipulating the handheld controller 101, more than one user may be able to observe and enjoy the virtual reality experience simultaneously.

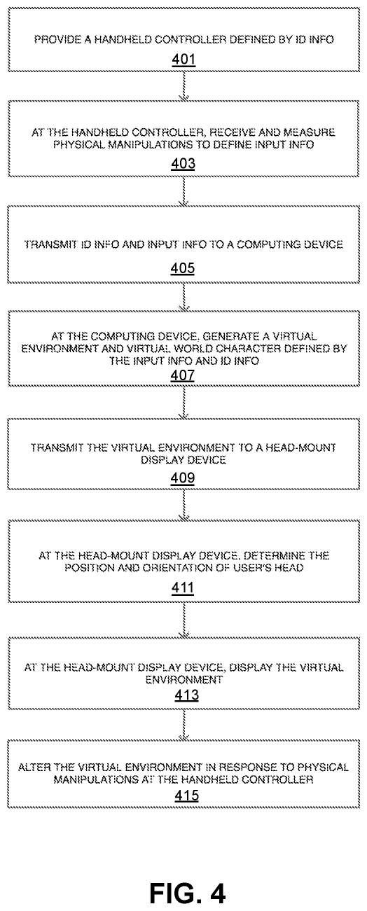

FIG. 4 is a flowchart depicting an exemplary embodiment of a system and method for controlling a virtual world character. As shown in FIG. 4, the method includes the steps of: providing at least one handheld controller configured as a desirable character defined by identity information (block 401); at the handheld controller, receiving and measuring physical manipulations of such handheld controller by a user to define input information (block 403); at the handheld controller, transmitting the identity information and input information to a computing device (block 405); at the computing device, receiving the transmitted identity information and input information from the handheld controller and generating a virtual environment (block 407); at the computing device, transmitting the virtual environment to a head-mount display device worn by the user (block 409); at the head-mount display device, determining the position and orientation of the user's head (block 411); at the head-mount display device, displaying the virtual environment (block 413); and altering the virtual environment in response to physical manipulations of the handheld controller, such that the actions and movements of the virtual world character mirror the physical manipulations of the handheld controller (block 415).

In some embodiments, the virtual environment may be generated (block 407) so as to automatically comprise a virtual world character defined by the identity information, that is, the virtual world character has the same appearance as the handheld controller. In other embodiments, the user may manually select identity information for the virtual world character that is different from the identity information of the controller. In still other embodiments, the user may manually select one or more aesthetic traits, one or more personality traits, and one or more skill traits of the virtual world character. Indeed, in such embodiments, one or more of the aesthetic traits, one or more of the personality traits, or one or more of the skill traits may differ from the identity information of the controller.

Determining the position and orientation of the user's head (block 411) may further comprise securing the head-mount display device to the user's head and automatically scaling the X axis, the Y axis, and the Z axis of the virtual environment so as to be corresponding and proportionate to the position and orientation of the user's head in real-world space. Moreover, as a function of the position and movement of the user's head within real-world space, the virtual environment may be displayed to the user via the head-mount display device (block 413). Indeed, the head-mount display device may automatically adapt the virtual environment as displayed to the user to consider these movements and the user's point of view may be accordingly adjusted. In some embodiments, the Y axis of the virtual environment may remain fixed at a predetermined height so as to mimic the point of view of the virtual world character. In some embodiments wherein the Y axis is fixed, upon movement of the virtual world character in the virtual environment, the user's point of view may track such movements along the X axis and Z axis of the virtual environment. In other embodiments wherein the Y axis is fixed, the user's point of view may be adjustable independent of movement of the virtual world character in the virtual environment.

Various types of physical manipulations of the handheld controller may be received and measured (block 403) in accordance with this invention. For instance, the handheld controller may be moved in an upward direction in real-world space. The physical manipulations may then be processed by the computing device and the virtual environment may be adapted such that the virtual world character may also travel in an upward direction. Similarly, the handheld controller may be jostled back-and-forth by the user and subsequently, the computing device may process the jostling movements and the virtual environment may be adapted such that the virtual world character may also move back-and-forth. Additionally, the handheld controller may comprise one or more input devices and the input devices may be directly physically manipulated by the user. In particular, the input devices may be pressed, pushed, or otherwise actuated. Upon such physical manipulations of the input devices, the computing device may process such manipulations and the virtual environment may then be adapted such that the virtual world character performs a predetermined action.

In certain embodiments, the input device may comprise a follow button. Upon actuation of the follow button, the virtual environment may be generated so as to fixate on the point of view of the virtual world character. In particular, the head-mount display device may display and update the virtual environment viewable to the user so as to track movements of the virtual world character. That is, the virtual environment as viewed by the user via the head-mount display device may correspond exactly to the actions and movements of the virtual world character. In such embodiments, the handheld controller may still be physically manipulated in real-world space and the virtual world character may correspondingly follow the physical manipulations in the virtual environment. Moreover, in some embodiments, re-actuation of the follow button may adapt the virtual environment so as to permit free viewing of the virtual environment by the user without regard to movements of the virtual world character. In these embodiments, as the user moves his or her head, the head-mount display device may display regions of the virtual environment independent of any actions or movements of the virtual world character.

In some embodiments, and as shown in FIG. 5, the input device may comprise a teleport trigger 210. The teleport trigger 210 may first be continuously actuated, that is, the teleport trigger 210 may be held down by the user. Upon such continuous actuation of the teleport trigger 210, the virtual environment may be adapted so as to display a single laser beam. The laser beam may then be manipulated around the virtual environment so as to determine a desirable location. Once the desirable location is determined by the user, the teleport trigger 210 may be released. Upon release of the teleport trigger 210, the user's point of view automatically shifts such that the user views the virtual environment from the point of view of the desirable location. In particular, the head-mount display device may display the virtual environment to the user from the point of view of the desirable location determined by the user. In such embodiments, the virtual world character may appear at a distance from the user's point of view, that is, the head-mount display device may adapt the user's view so as to render the virtual world character further away in the virtual environment. In such embodiments, the handheld controller 101 may be physically manipulated. Upon receipt of these physical manipulations, the virtual environment may be altered and the actions and movements of the virtual world character may correspondingly mirror the physical manipulations of the controller 101.

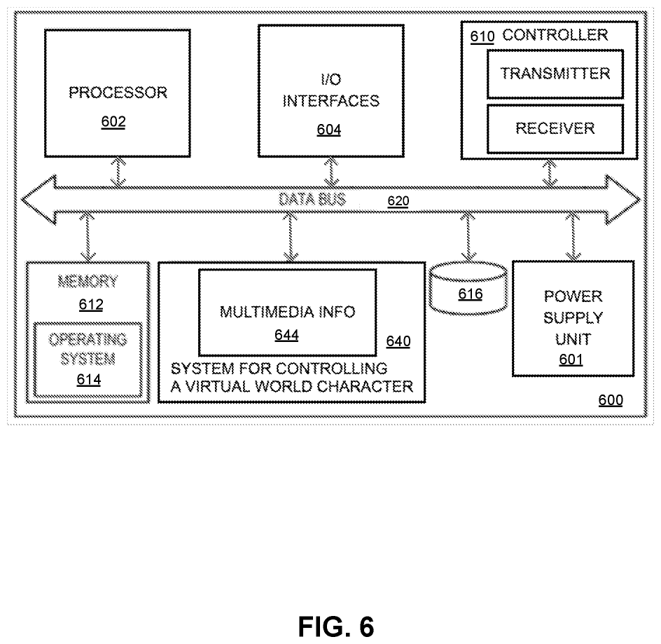

FIG. 6 illustrates an exemplary computing device 600 configured to implement the system for controlling a virtual world character. Computing device 600 may be a desktop computer, laptop, gaming console, or even tablet computer but may also be embodied in any one of a wide variety of wired and/or wireless computing devices known to those skilled in the art. The computing device 600 may include a processing device (processor) 602, input/output interfaces 604, a controller 610 having a transmitter and receiver, a memory 612, and operating system 614, and a mass storage 616, with each communicating across a local data bus 620. Additionally, computing device 600 may incorporate a system 640 for controlling a virtual world character, multimedia information 644 received from the handheld controller, although the location of information 644 could vary. The computing device 600 may further comprise a power supply 601.

The processor 602 may include any custom made or commercially available processor, a central processing unit (CPU) or an auxiliary processor among several processors associated with the computing device 600, a semiconductor based microprocessor (in the form of a microchip), a macroprocessor, one or more application specific integrated circuits (ASICs), a plurality of suitably configured digital logic gates, and other electrical configurations comprising discrete elements both individually and in various combinations to coordinate the overall operation of the system.

The memory 612 can include any one of a combination of volatile memory elements (e.g., random-access memory (RAM, such as DRAM, and SRAM, etc.)) and nonvolatile memory elements. The memory typically comprises native operating system 1114, one or more native applications, emulation systems, or emulated applications for any of a variety of operating systems and/or emulated hardware platforms, emulated operating systems, etc. For example, the applications may include application specific software which may comprise some or all the components of the computing device 600. In accordance with such embodiments, the components are stored in memory and executed by the processing device. Note that although depicted separately, the system 640 may be resident in memory such as memory 612.

One of ordinary skill in the art will appreciate that the memory 614 can, and typically will, comprise other components which have been omitted for purposes of brevity. Note that in the context of this disclosure, a non-transitory computer-readable medium stores one or more programs for use by or in connection with an instruction execution system, apparatus, or device. The controller 610 comprises various components used to transmit and/or receive data over a networked environment such as depicted in FIG. 1. When such components are embodied as an application, the one or more components may be stored on a non-transitory computer-readable medium and executed by the processor.

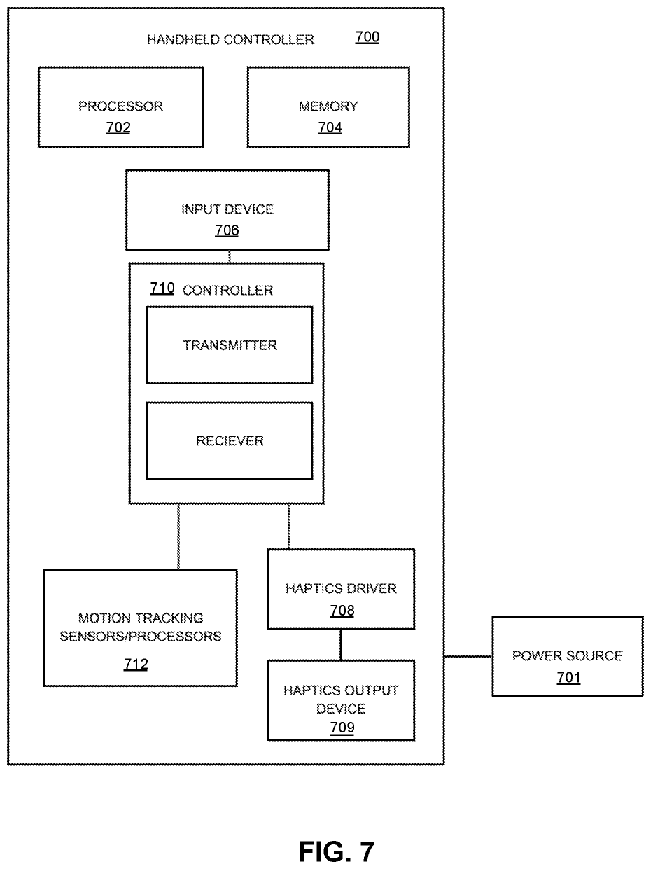

FIG. 7 illustrates an exemplary handheld controller 700 configured to implement the system for controlling a virtual world character. Handheld controller 700 may be commercially available or custom made and including gamepads, joysticks, or keyboards but may also be embodied in any one of a wide variety of wired and/or wireless handheld gaming controllers known to those skilled in the art. The handheld controller 700 may include a processing device (processor) 702, a memory 704, input devices 706, a controller 710 having a transmitter and receiver, a motion tracking sensors/processor 712, a haptics driver 708 and a haptic output device 709. Additionally, handheld controller 700 may be electronically coupled to a power source 701. The processor 702 may include any custom made or commercially available processor, such as those discussed above. Moreover, the memory 704 may include any one of a combination of volatile memory elements and nonvolatile memory elements, such as those discussed above.

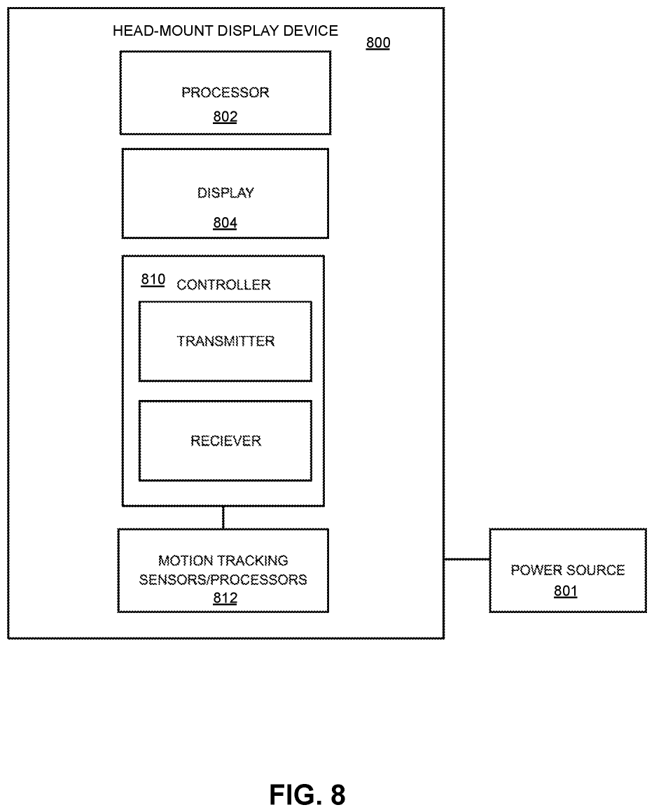

FIG. 8 depicts an exemplary head-mount display device 800 configured to implement the system for controlling a virtual world character. Head-mount display device 800 may be commercially available or custom made. The head-mount display device 800 may include a processing device (processor) 802, a display 804, a controller 810 having a transmitter and receiver, and a motion tracking sensors/processor 812. Additionally, the head-mount display device 800 may be electronically coupled to a power source 801. The processor 802 may include any custom made or commercially available processor, such as those discussed above.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### CONCLUSIONS, RAMIFICATIONS, AND SCOPE

While certain embodiments of the invention have been illustrated and described, various modifications are contemplated and can be made without departing from the spirit and scope of the invention. For example, any multimedia information comprising the system may vary depending on the desired style of gameplay. As another example, the number of users may increase from one to as many users as desired. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the system and method for controlling a virtual world character with which that terminology is associated. In general, the terms used in the following claims should not be constructed to limit the system and method for controlling a virtual world character to the specific embodiments disclosed in the specification unless the above description section explicitly define such terms. Accordingly, the actual scope encompasses not only the disclosed embodiments, but also all equivalent ways of practicing or implementing the disclosed system, method and apparatus. The above description of embodiments of the system and method for controlling a virtual world character is not intended to be exhaustive or limited to the precise form disclosed above or to a particular field of usage.

While specific embodiments of, and examples for, the method, system, and apparatus are described above for illustrative purposes, various equivalent modifications are possible for which those skilled in the relevant art will recognize.

While certain aspects of the method and system disclosed are presented below in particular claim forms, various aspects of the method, system, and apparatus are contemplated in any number of claim forms. Thus, the inventor reserves the right to add additional claims after filing the application to pursue such additional claim forms for other aspects of the system and method for controlling a virtual world character

What is claimed is:

1. A system for controlling a virtual world character, comprising
a handheld controller defined by identity information, the handheld controller operative to
store the identity information;
measure any physical manipulations of the handheld controller by a user to generate input information;
transmit the identity information and input information;
a computing device operative to
receive the identity information and input information transmitted by the handheld controller;
generate a virtual environment in accordance with the identity information and the input information;
generate output information defined by the virtual environment, input information, and identity information; and
transmit the output information;
a head-mount display device, configured to be worn on the user's head, and operative to
determine the position and orientation of the user's head;
receive the output information from the computing device;
display the virtual environment according to the position and orientation of the user's head and the output information;
wherein the identity information defines a virtual world character and the virtual world character has the same appearance as the handheld controller.

2. The system of claim 1, wherein the controller comprises one or more input devices operative to receive physical manipulations by the user.

3. The system of claim 2, wherein the one or more input devices are adapted to change the actions of the virtual world character within the virtual environment.

4. The system of claim 2, wherein the controller is further operative to provide force feedback to the user when the one or more input devices are actuated.

5. The system of claim 1, wherein the identity information comprises one or more aesthetic traits, one or more personality traits, and one or more skill traits.

6. The system of claim 1, wherein the head-mount display device comprises:
one or more sensors operative to determine the position and orientation of the user's head; and
a visual display, operative to display the virtual environment to the user.

7. The system of claim 6, further comprising a monitor operative to display the virtual environment such that the display mirrors the visual display viewed by the user wearing the head-mount display device.

8. A method for controlling a virtual world character, comprising:
providing at least one handheld controller configured as a desirable character defined by identity information,
at the handheld controller,
a) receiving and measuring physical manipulations of such handheld controller by a user to define input information;
b) transmitting the identity information and input information to a computing device;
at the computing device, receiving the transmitted identity information and input information from the handheld controller and generating a virtual environment comprising
a) the input information and
b) a virtual world character defined by the identity information and having the same appearance as the handheld controller;
at the computing device, transmitting the virtual environment to a head-mount display device worn by the user;
at the head-mount display device,
a) determining the position and orientation of the user's head;
b) displaying the virtual environment;
altering the virtual environment in response to physical manipulations of the handheld controller, such that the actions and movements of the virtual world character mirror the physical manipulations of the handheld controller.
